(19) United States
(12) Patent Application Publication
(10) Pub. No.: US 2023/0316320 A1
(43) Pub. Date: Oct. 5, 2023

(54) VALUE CONVERSION OF USER BEHAVIORAL DATA

(71) Applicant: Sony Group Corporation, Tokyo (JP)

(72) Inventors: Ted Yamazaki, Tokyo (JP); Steve Saito, Tokyo (JP); Makoto Sasaki, Tokyo (JP); Tetsugoro Ihara, Tokyo (JP); Hitoshi Yamane, Tokyo (JP); Koji Miura, Tokyo (JP); Tonni Sandager Larsen, San Diego, CA (US)

(73) Assignee: Sony Group Corporation, Tokyo (JP)

(21) Appl. No.: 17/894,381

(22) Filed: Aug. 24, 2022

Related U.S. Application Data
(60) Provisional application No. 63/362,062, filed on Mar. 29, 2022.

(51) Int. Cl. G06Q 30/02; G06Q 30/00

(52) U.S. Cl. CPC G06Q 30/0224; G06Q 30/018

(57) ABSTRACT

Implementations generally relate to tracking of user behavioral data in various environments where a user performs various activities. In some implementations, a method includes tracking, using capture devices, user behavior of a user, wherein the capture devices capture the user behavior performed by the user in environments associated with the user. The method further includes identifying target behaviors from the user behavior. The method further includes computing behavior scores for each target behavior of the target behaviors based on predetermined scoring criteria. The method further includes converting the behavior scores into behavior credits based on predetermined credit criteria. The method further includes displaying a summary of the user behavior to the user, wherein the summary comprises information associated with the target behaviors, the behavior scores, and the behavior credits enabling the user to redeem the behavior credits.

### CROSS REFERENCE TO RELATED APPLICATIONS

This application claims the benefit of U.S. Provisional Patent Application Ser. No. 63/362,062, entitled “Value conversion of user behavioral data”, filed on Mar. 29, 2022 (SYP348508US01), which is hereby incorporated by reference as if set forth in full in this application for all purposes.

### BACKGROUND

User historical behavioral data is typically tracked by device makers, advertisers, and service providers, which provide search, browsing, and purchasing functions through connected devices. Typically, the only benefits for users are more relevant advertisements, targeted up-sell/cross-sell promotions, timely maintenance reminders (e.g., oil change reminders, etc.), or points/coupons that can be used for only limited purposes. Some servicers provide reward points or coupons to users who make purchases or who use their services, where users can exchange points for specific prizes or receive benefits such as discount services, which can be recognized as a return of value to the user. However, the points are usually merely used as loyalty rewards and not actual payment for data collected. Points are usually to be used only for select services or products provided by the servicer and are typically restricted to individual provider's policies regarding expiration dates and values.

### SUMMARY

Implementations generally relate to value conversion of user behavioral data. In various implementations, the system collects user behavior and converts observed behavior into value. As described in more detail herein, the system provides value converted from user behavior in the form of behavior scores and behavior credits that the user may redeem for various benefits or rewards. The system also provides visibility of the user behavior and associated behavior scores and behavior credits. In various implementations, users own and control their behavior data, and control how the converted behavior credits are redeemed. As a result, implementations provide incentives for user behavior that is beneficial to society, yet personally benefits users in the form of incentives and rewards to the user.

In some implementations, a system includes one or more processors, and includes logic encoded in one or more non-transitory computer-readable storage media for execution by the one or more processors. When executed, the logic is operable to cause the one or more processors to perform operations including: tracking, using capture devices, user behavior of a user, wherein the capture devices capture the user behavior performed by the user in environments associated with the user; identifying target behaviors from the user behavior; computing behavior scores for each target behavior of the target behaviors based on predetermined scoring criteria; converting the behavior scores into behavior credits based on predetermined credit criteria; displaying a summary of the user behavior to the user, wherein the summary comprises information associated with the target behaviors, the behavior scores, and the behavior credits; and enabling the user to redeem the behavior credits.

With further regard to the system, in some implementations, at least some of the predetermined scoring criteria are based on user activity in a mobility environment. In some implementations, at least some of the predetermined scoring criteria are based on user activity in a metaverse environment. In some implementations, the logic when executed is further operable to cause the one or more processors to perform operations comprising enabling the behavior credits to be redeemed in one or more of the environments associated with the user. In some implementations, the logic when executed is further operable to cause the one or more processors to perform operations comprising enabling the user to redeem behavior credits derived from behavior scores derived from a mobility environment to a metaverse environment. In some implementations, the logic when executed is further operable to cause the one or more processors to perform operations comprising enabling the user to redeem behavior credits derived from behavior scores derived from a metaverse environments to a mobility environment. In some implementations, the logic when executed is further operable to cause the one or more processors to perform operations comprising converting at least a portion of the behavior credits to sustainability credits.

In some implementations, a non-transitory computer-readable storage medium with program instructions thereon is provided. When executed by one or more processors, the instructions are operable to cause the one or more processors to perform operations including: tracking, using capture devices, user behavior of a user, wherein the capture devices capture the user behavior performed by the user in environments associated with the user; identifying target behaviors from the user behavior; computing behavior scores for each target behavior of the target behaviors based on predetermined scoring criteria; converting the behavior scores into behavior credits based on predetermined credit criteria; displaying a summary of the user behavior to the user, wherein the summary comprises information associated with the target behaviors, the behavior scores, and the behavior credits; and enabling the user to redeem the behavior credits.

With further regard to the computer-readable storage medium, in some implementations, at least some of the predetermined scoring criteria are based on user activity in a mobility environment. In some implementations, at least some of the predetermined scoring criteria are based on user activity in a metaverse environment, which may include gaming. In some implementations, the instructions when executed are further operable to cause the one or more processors to perform operations comprising enabling the behavior credits to be redeemed in one or more of the environments associated with the user. In some implementations, the instructions when executed are further operable to cause the one or more processors to perform operations comprising enabling of the user to redeem behavior credits derived from behavior scores derived from a mobility environment to a metaverse environment. In some implementations, the instructions when executed are further operable to cause the one or more processors to perform operations comprising enabling of the user to redeem behavior credits derived from behavior scores derived from a metaverse environment to a mobility environment. In some implementations, the instructions when executed are further operable to cause the one or more processors to perform operations comprising converting at least a portion of the behavior credits to sustainability credits.

In some implementations, a method includes: tracking, using capture devices, user behavior of a user, wherein the capture devices capture the user behavior performed by the user in environments associated with the user; identifying target behaviors from the user behavior; computing behavior scores for each target behavior of the target behaviors based on predetermined scoring criteria; converting the behavior scores into behavior credits based on predetermined credit criteria; displaying a summary of the user behavior to the user, wherein the summary comprises information associated with the target behaviors, the behavior scores, and the behavior credits; and enabling the user to redeem the behavior credits.

With further regard to the method, in some implementations, at least some of the predetermined scoring criteria are based on user activity in a mobility environment. In some implementations, at least some of the predetermined scoring criteria are based on user activity in a metaverse environment. In some implementations, the method further includes enabling the behavior credits to be redeemed in one or more of the environments associated with the user. In some implementations, the method further includes enabling of the user to redeem behavior credits derived from behavior scores derived from a mobility environment to a metaverse environment. In some implementations, the method further includes enabling the user to redeem behavior credits derived from behavior scores derived from a metaverse environment to a mobility environment.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example network environment for converting values of user behavioral data, which may be used for implementations described herein.

FIG. 2 is an example flow diagram for value conversion of user behavioral data, according to some implementations.

FIG. 3 is an example conversion diagram showing example parameters for value conversion of user behavioral data, according to some implementations.

FIG. 4 is a chart showing example mobility parameters and types of parameter-to-parameter conversions, according to some implementations.

FIG. 5 is a chart showing example metaverse parameters and types of parameter-to-parameter conversions, according to some implementations.

FIG. 6 is a chart showing example service parameters and types of parameter-to-parameter conversions, according to some implementations.

FIG. 7 is an example network environment including a summary, according to some implementations.

FIG. 8 is an example diagram of a mobile application, according to some implementations.

FIG. 9 is a block diagram of an example network environment, which may be used for some implementations described herein.

FIG. 10 is a block diagram of an example computer system, which may be used for some implementations described herein.

### DETAILED DESCRIPTION

Implementations described herein convert user behavior to value in the form of behavior credit that a user may redeem for various benefits. As described in more detail herein, in various implementations, a system tracks, using capture devices, user behavior, wherein the capture devices capture the user behavior performed by the user in environments associated with the user. The system further identifies target behaviors from the user behavior. The system further computes behavior scores for each target behavior of the target behaviors based on predetermined scoring criteria. The system further converts the behavior scores into behavior credits based on predetermined credit criteria. The system further displays a summary of the user behavior to the user, wherein the summary comprises information associated with the target behaviors, the behavior scores, and the behavior credits. The system further enables the user to redeem the behavior credits.

Although implementations disclosed herein are described in the context of mobility and metaverse environments, the implementations may also apply to other environments. For example, a metaverse environment may include one or more gaming environments. As such, implementations described herein described in the context of a metaverse environment apply to gaming environments.

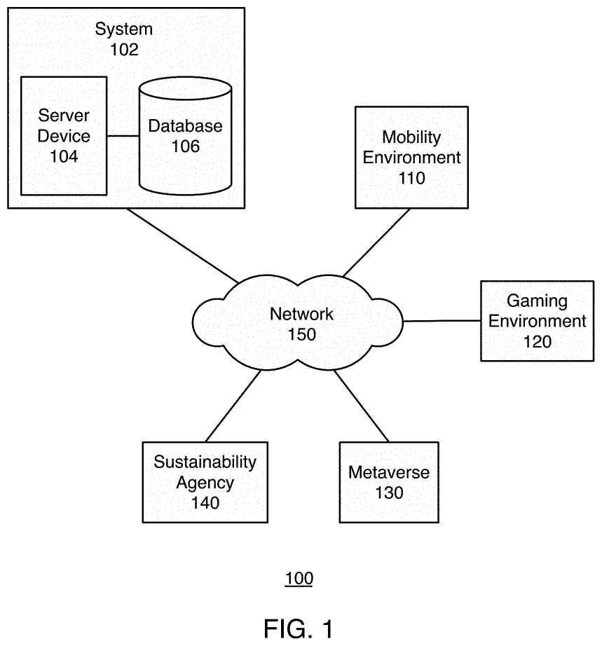

FIG. 1 is a block diagram of an example network environment 100 for converting values of user behavioral data, which may be used for implementations described herein. Shown are system 102, which includes a server device 104 and database 106. Also shown are a mobility environment 110, a gaming environment 120, a metaverse environment 130, and a sustainability agency 140, all of which may communicate with each other via a network 150. Network 150 may be any suitable communication network such as a Bluetooth network, a Wi-Fi network, the Internet, 5G, 6G, satellite constellations, etc.

In various implementations, the system enables the user to provide the user's own capture devices to observe user behavior, which may include a dashboard camera or other external capture devices. The system may use such in-cabin capture devices to obverse user behavior such as facial expressions, gestures, etc. Other capture devices may observe traffic conditions. The user may also use devices that are integrated with the user's car. Such integrated devices observe vehicle behavior (e.g., acceleration, breaking, steering, etc.) associated with actions of the user.

For ease of illustration, FIG. 1 shows one block for each of system 102, server device 104, and network database 106, and shows four blocks for mobility environment 110, gaming environment 120, metaverse or metaverse environment 130, and sustainability agency 140. Blocks 102, 104, and 106 may represent multiple systems, server devices, and network databases. Also, there may be any number of environments. In other implementations, environment 100 may not have all of the components shown and/or may have other elements including other types of elements instead of, or in addition to, those shown herein.

While system 102 performs implementations described herein, in other implementations, any suitable component or combination of components associated with system 102 or any suitable processor or processors associated with system 102 may facilitate performing the implementations described herein.

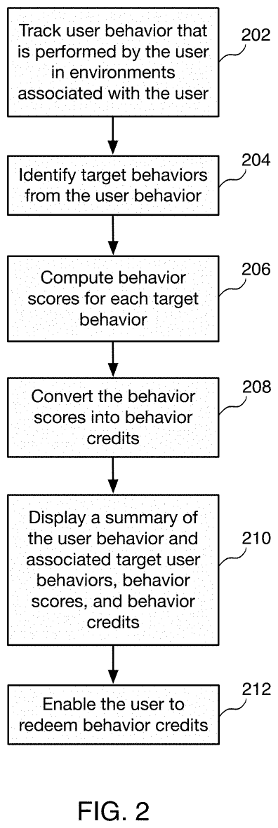

FIG. 2 is an example flow diagram for value conversion of user behavioral data, according to some implementations. Referring to both FIGS. 1 and 2, a method is initiated at block 202, where a system such as system 102 tracks user behavior by use of various capture devices. In various implementations, the capture devices capture the user behavior in environments associated with the user. As described in various implementations described herein, such environments may include mobility environments and metaverse environments, including gaming. Examples of capture devices and their tracking or monitoring of user behavior are described in more detail herein.

Mobility environments may include environments associated with a user traveling in the physical world (e.g., from one location to another). For example, such traveling may include the user commuting to work and back home, going shopping, delivering items to particular destinations, etc. While various example implementations are described herein in the context of driving an automobile, these implementations and others may apply to any form of transportation (e.g., driving a delivery truck, taking public transportation, riding a bicycle, walking, etc.). For example, as described in more detail herein, the system may encourage or incentivize a user for driving less distance during a given day by combining errands with commuting to work. In another example, the system may encourage a user to carpool, take public transportation, bicycle, or walk for at least one travel.

Metaverse environments may include environments associated with a user playing video games. Metaverse environments such as gaming environments may include virtual worlds in which a user plays video games. Metaverse environments, including gaming environments may also include physical environments in which a user plays video games.

While various implementations are described herein in the context of mobility and metaverse environments, these implementations and others also apply to other environments. For example, environments may include home and work environments where the system may incentivize various user behaviors such as conserving on electricity usage, water usage, etc.

In some implementations, environments may include hybrid environments, which may include different types of environments associated with the user. For example, a user may play a video game or explore the metaverse at a car dealership, at a charging station, in a garage, etc. As such, a car dealership, charging station, and garage may be considered as both a mobility environment and a metaverse environments, including gaming.

In various implementations, such as in this example, the purpose of exploring the metaverse or playing video games may vary. For example, a user may play a video game for entertainment. A user may also explore the metaverse or play a video game for training and/or assessment. In a more specific example, a user at a car dealership may explore metaverse or play a video game that involve driving in order to obtain driving skills for more efficient driving, or to learn and practice using particular driving features of a prospective car (e.g., cruise control, maps, etc.). Further examples of mobility and metaverse environments, including gaming, and the tracking or monitoring of user behavior in these and other types of environments are described in more detail herein.

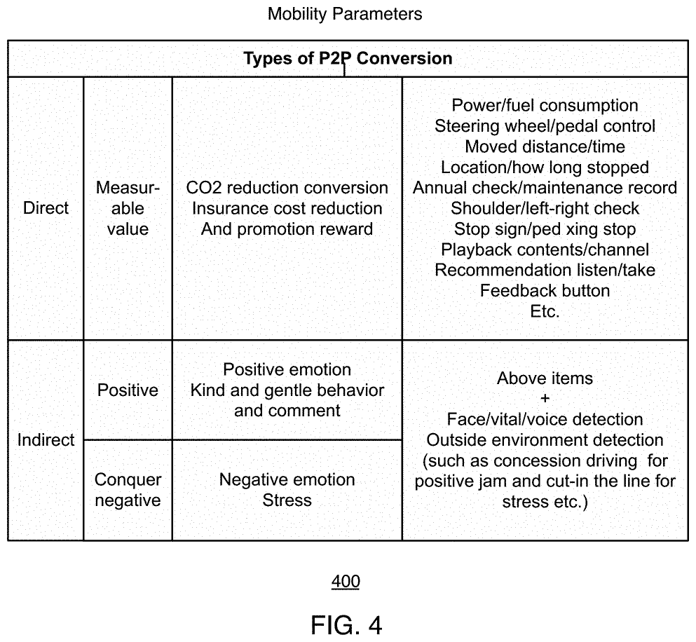

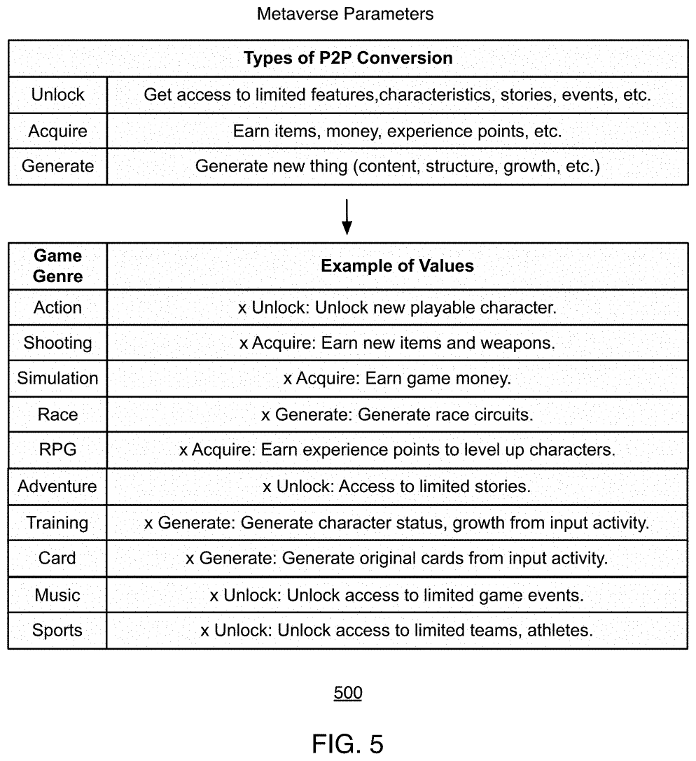

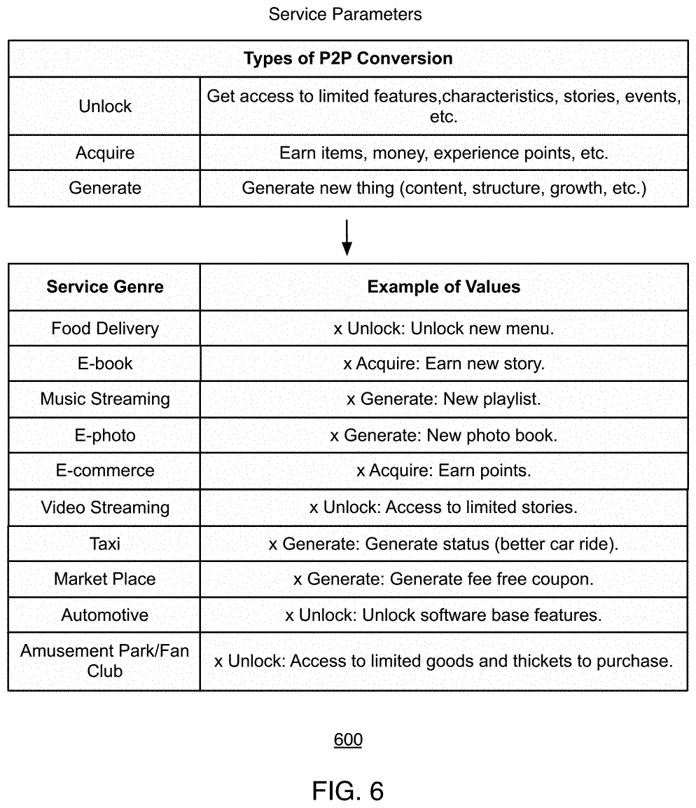

At block 204, the system identifies target behaviors from the user behavior. In various implementations, target behaviors may include desired behaviors that are incentivized by the system. For example, in a mobility environment, target behaviors may include driving a car at an optimal speed, driving less distance among different route options, taking optimal routes, etc. Various target behaviors in different types of environments are described in more detail herein, in connection with FIG. 4, FIG. 5, and FIG. 6, for example.

In various implementations, the system may identify target behaviors using data received from a variety of capture devices such as cameras, vehicle monitoring devices, etc. The system may appropriate artificial intelligence (AI) and machine learning technologies to assess behavior and identify discrete actions and/or a series of actions for analysis and processing. For example, actions may be related to maneuvering a car (e.g., accelerating, breaking, steering, etc.). Actions may include gestures such as a friendly hand gesture to allow another car to proceed first at a stop sign, waiving a tight first out of the window after breaking from being cut off. The actions identified may vary, depending on the particular implementation, which may include the particular type of environment.

At block 206, the system computes behavior scores for each target behavior of the target behaviors based on predetermined scoring criteria. As described in more detail herein, predetermined scoring criteria may be based on parameters associated with different environments. The following descriptions describe example predetermined scoring criteria involving parameters associated with mobility and metaverse environments.

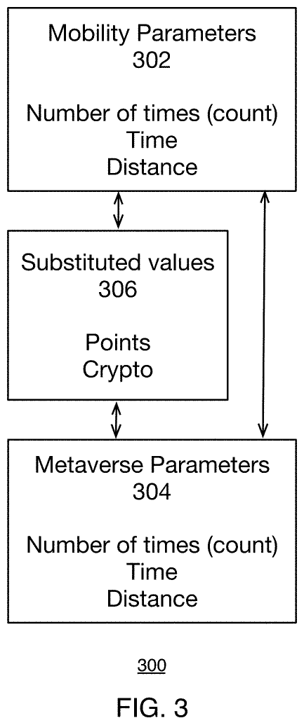

FIG. 3 is an example conversion diagram 300 showing example parameters for value conversion of user behavioral data, according to some implementations. Shown are mobility parameters 302, metaverse parameters 304, which may include gaming parameters, and substituted values 306.

In various implementations, both mobility parameters 302 and metaverse parameters 304 involve a number of times (count), time or duration, and distance associated with particular actions. Substitute values 306 may include a crypto credit that the user may redeem for crypto currencies (labeled Crypto).

In various implementations, at least some of the predetermined scoring criteria are based on user activity in a mobility environment. Also, in various implementations, at least some of the predetermined scoring criteria are based on user activity in a metaverse environment.

As indicated above, mobility parameters may involve a number of times (count) that particular user behavior occurs in the mobility environment, and metaverse parameters or gaming parameters may involve a number of times (count) that a particular user behavior occurs in the metaverse environments. The system uses these parameters to convert user behavior and more specifically user actions into value in the form of scores.

The following expression describes how the system generates counts of user actions that occur in the mobility and metaverse environments.

$$Count A = \frac{{\sum }_{i = 1}^{k} Ai ai}{k} = \frac{{\sum }_{i = 1}^{k} Bi bi}{k} = Count B$$

In various implementations, Ai may represent counts of user actions (e.g., expressing positive or stressful feelings, etc.), and ai may represent circumstances (e.g., traffic conditions, personal status, etc.) associated with the mobility environment. Also, Bi may represent counts of user actions (e.g., obtaining specific virtual items while exploring the metaverse or while playing a video game, etc.), and bi may represent circumstances (e.g., traffic conditions, personal status, etc.) associated with the metaverse environments. In various implementations, the system computes and stores these counts throughout the day, and then sums and stores a daily accumulated numbers (counts) Count A and Count B.

In some implementations, Count A may represent the accumulated number of times the user achieved positive feelings or stressed feelings. In some implementations, the counts associated with each instance of the action may be weighted based on the circumstances. For example, the system may increment Count A by one if the user expresses a positive feeling during normal traffic. In another scenario, the system may increment Count A by a predetermined weighted amount greater than one if the user expresses a positive feeling during heavy traffic.

In some implementations, Count B may represent the accumulated number of times the user obtained a specific virtual item in a video game or metaverse exploring. In some implementations, the counts associated with each instance of the action may be weighted based on the circumstances. For example, the system may increment Count B by one if the user obtains a particular object during a first metaverse level. In another scenario, the system may increment Count B by a predetermined weighted amount greater than one if the user obtains a particular object during a higher, second metaverse level.

In various implementations, the values Count A and Count B may be exchanged between the mobility and metaverse environments. Also, the system converts these accumulated counts into behavior scores. Described in more detail below are times and distances that are computed with respect to the mobility and metaverse environments, where the system converts average times and accumulated distances to behavior scores. These scores may also be exchanged between the mobility and metaverse environments.

The following expression describes how the system generates times of user actions that occur in the mobility and metaverse environments.

$$Time A = \frac{{\sum }_{i = 1}^{k} Ai ai}{k} = \frac{{\sum }_{i = 1}^{k} Bi bi}{k} = Time B$$

In various implementations, Ai may represent times (time durations) of user actions (e.g., depressing the gas pedal, regenerating electricity when releasing the gas pedal in an electric vehicle (EV), etc.) in the mobility environment. The term ai may represent circumstances (e.g., the user driving an electronic vehicle in a power mode, a normal mode, and an ecological (eco) mode. Bi may represent times (time durations) of user actions (e.g., obtaining a specific, virtual items with a CO2 tag while exploring the metaverse or while playing a video game, leveling up with CO2 tag, etc.), and bi may represent circumstances (e.g., game level status, etc.) associated with the metaverse environments. In various implementations, the system computes and stores these times throughout the day, and then averages and stores a daily average times Time A and Time B. Implementations directed to CO2 tags are described in more detail below.

In various implementations, the system may provide charity- or donation-based challenge settings such as in eSports or for sustainable development goals (SDGs). The system may enable contributions based on sponsor, audience, player, and supporter contributions, which enables users to collaborate to contribute to CO2 reduction. For example, suppose users take some virtual trips in the metaverse rather than take real trips in the physical world. The system may provide CO2 tag items in the metaverse field or video game field. If a given user succeeds in a challenge, the system may reward the user with a CO2 tag. In various implementations, the system may enable the user to contribute or donate the value of the CO2 for CO2 reduction. The system creating such virtual paths and/or scenarios to explore provides users with an option of refraining from real-world trips that consume much CO2. In various implementations, the system may enable funding support from government and/or public entities. As such, according to implementations described herein, if a score can be visualized or displayed to users and utilized as proof of contribution (e.g., to CO2 reduction, etc.) by a user or by a community of users, the system may enable users (e.g., students) to utilize their scores as the credential of social contribution. Such credentials may aid in their enrollment applications to universities and/or corporations. In various implementations, such credentials may be securely managed by blockchain technology.

In some implementations, Time A may represent an average of times that the user performed particular actions described above, and the system associates these times with user behavior contributing to CO2 reduction. In some implementations, the times associated with each instance of the action may be weighted based on the circumstances. For example, the system may increase Time A by a predetermined amount if the user performs one or more of these actions during a normal mode. In another scenario, the system may increase Time A by a greater predetermined weighted amount if the user performs one or more of these actions during an eco mode.

In some implementations, Time B may represent an average of times that it took the user to perform virtual actions while exploring the metaverse or while playing a video game. In some implementations, the times associated with each instance of the action may be weighted based on the circumstances. For example, the system may increase Time B by a predetermined amount if the user performs the action during a first metaverse level. In another scenario, the system may increase Time B by a greater predetermined weighted amount greater if the user performs the action during a higher, second metaverse level.

In various implementations, the values Time A and Time B may be exchanged between the mobility and metaverse environments. Also, the system converts these average times into behavior scores.

The following expression describes how the system generates distances of user actions that occur in the mobility and metaverse environments.

$$Distance A = \frac{{\sum }_{i = 1}^{k} Ai ai}{k} = \frac{{\sum }_{i = 1}^{k} Bi bi}{k} = Distance B$$

In various implementations, Ai may represent distances traveled by the user (e.g., distance to work, distance running errands, distance making deliveries, etc.), and ai may represent circumstances such as modes of transportation (e.g., driving, taking public transit, bicycling, walking, etc.) associated with the mobility environment. Also, Bi may represent distances moving through a virtual world or metaverse in a video game, and bi may represent circumstances (e.g., game levels, stage/world locations, methods of transportation, etc.) associated with the metaverse environment. In various implementations, the system computes and stores these counts throughout the day, and then sums and stores daily distances Distance A and Distance B.

In some implementations, Distance A may represent the accumulated distance that the user traveled to various destinations. Because a shorter distance by car would be more ecological, the system incentivizes the user to travel less by car or more by bicycle or by foot. As such, in various implementations, a shorter distance results in a higher behavior score than a longer distance. In some implementations, the distance associated with each destination may be weighted based on the circumstances. For example, the system may decrease Distance A by a predetermined amount if the user traveled a particular route using an electronic vehicle or mass transit. In another scenario, the system may decrease Distance A by a greater predetermined weighted amount if the user traveled a particular route by bicycle or by foot. In other words, the shorter the accumulated distance traveled and the more the user uses more ecological means of travel, the higher the resulting behavior score.

In some implementations, Distance B may represent an accumulated distance that the user traveled to various virtual destinations in a video game or metaverse. In some implementations, the distance associated with each instance of travel may be weighted based on the circumstances. For example, the system may decrease Distance B by a predetermined amount if the user travels at a higher game level or travels using a more ecological method of transportation. In another scenario, the system may decrease Distance B by a greater predetermined weighted amount if the user travels by virtual bicycle or by foot in the video game or while exploring the metaverse. The shorter the accumulated distance traveled and the more the user uses more ecological means of travel, the higher the resulting behavior score.

In various implementations, the values Distance A and Distance B may be exchanged between the mobility and metaverse environments. Also, the system converts these accumulated distances into behavior scores.

As indicated above, the system converts these accumulated counts, average times, and accumulated distances into behavior scores, which are associated with respective mobility and metaverse environments. These behavior scores may be exchanged between the mobility and metaverse environments. As described in more detail herein, in various implementations, the system converts these behavior scores to user behavior credits, which the user may redeem. These user behavior credits may be exchanged between the mobility and metaverse environments, including gaming environments.

While some scores are described herein in the context of accumulated counts, average times, and accumulated distances, implementations associated with these values may be applied to other target behaviors. In other words, the system may generate behavior scores and ultimately behavior credits based on a variety of other target behaviors. For example, in a mobility environment, the system may generate a score for driving speed, for acceleration, breaking, etc. The system may generate a higher score for driving the speed limit, smooth acceleration, smooth breaking, etc. This type of driving is consistent with more ecological and safe driving. In contrast, the system may generate a lower score for speeding, overly rapid acceleration (e.g., peeling out), hard breaking, etc.

In a metaverse environments, the system may also generate metaverse scores or gaming scores for achievements such as the user performing certain challenging tasks in the metaverse or in a video game, for advancing to a higher metaverse or game level, etc. If the video is a driving game or a metaverse exploration, the system may generate metaverse scores or gaming scores for actions corresponding to virtual driving actions, similar to physical driving actions. For example, the system may generate a higher score for virtually driving the speed limit, smooth acceleration, smooth breaking, etc. In contrast, the system may generate a lower score for virtually speeding, overly rapid acceleration (e.g., peeling out), hard breaking, etc. The system may utilize AI and machine learning to learn behavior patterns of the virtual driver and adjust scoring accordingly. Further example implementations directed to the computing of behavior scores associated with a metaverse environment are described in more detail herein.

In various implementations, the system may utilize artificial intelligence (AI) and machine learning to learn and identify target behaviors, as well as identify patterns of the driver behavior and adjust behavior scoring accordingly. For example, the system may determine a pattern of repeated rapid acceleration and hard breaking of a particular user, and compute a score accordingly. If the user breaks hard to avoid an accident, yet has a pattern of smooth breaking, the system may generate a higher score for avoiding an accident. The system may aggregate all behavior scores in particular categories (e.g., mobility environment category, metaverse environments category, etc.).

In various implementations, the system may generate value from user behavior based on a variety of parameters, where target behaviors such as those described above are associated with particular parameters. While some parameters are described in the context of mobility environments and metaverse environments, parameters in other environments are possible such as in service enterprises.

Referring still to FIG. 2, at block 208, the system converts the behavior scores into behavior credits based on predetermined credit criteria. For example, the system may convert at least a portion of the behavior score into behavior credits in order to enable the user to choose how to use or redeem the behavior credits. The conversions may be based on target uses for the behavior credits. For example, some behavior credits may be intended to be transferred to one more other types of environments for the benefit of the user. For example, system may convert mobility scores derived from user behavior in a mobility environment into mobility credit. In another example, the system may convert metaverse scores or gaming scores derived from user behavior in a metaverse environment or gaming environment into metaverse credit or gaming credit.

In some implementations, the system may convert behavior scores derived from user behavior in one environment (e.g., mobility) to credits for another environment (e.g., metaverse). For example, in some implementations, the system may convert mobility scores directly to metaverse credits. Multiple conversions are also possible. For example, the system may initially convert mobility scores to mobility credits, and subsequently convert some mobility credits to metaverse credits.

The system may store the converted credits in the originating environment (e.g., mobility) or transfer the converted credits to a target environment (e.g., metaverse). In various implementations, the system may enable the user to select a type of target credits to covert to, and may also enable the user to select where and when to transfer such target credits.

FIG. 4 is a chart 400 showing example mobility parameters and types of parameter-to-parameter (P2P) conversions, according to some implementations. Shown are direct and indirect parameters, where direct parameters included measurable value parameters and indirect parameters include parameters in positive parameters overcoming or conquering negative parameter described herein.

In various implementations, P2P conversions may include CO2 reduction conversions, insurance cost reductions, and ad promotion reward conversions. These conversions may be based on any combination of user behavior associated with power/fuel consumption, steering wheel/pedal control, moved distance/time, location, how long stopped, annual check/maintenance recode, shoulder/left-right check, stop sign/pedestrian crossing stop, playback contents/channel recommendation listen/take, feedback button, etc.

With regard to positive parameters, in various implementations, P2P conversions may be associated with positive emotion, kind and gentle behavior and comment. With regard to the “conquer negative” category, conversions may be associated with overcoming negative emotions or stress. These conversions may be based on any combination of those described above in association with measurable values, as well as face/vital/voice detection, outside environment detection (e.g., concession driving for being positive in traffic jams or from someone cutting in a line, from stress, etc.).

FIG. 5 is a chart 500 showing example metaverse parameters and types of parameter-to-parameter (P2P) conversions, according to some implementations. Shown are parameters associated with unlock, acquire, and generate functions. In some implementations, an unlock function enables a user to get access to limited features, characters, stories, events, etc. An acquire function may enable a user to earn items, money, experience points, etc. A generate function may entail the system generating a new item (e.g., content, structure, growth, etc.)

In various embodiments, the following include game or metaverse genres and examples of associated values that may be redeemed. An action genre may involve the system unlocking a new playable character. A shooting genre may involve the system enabling a user to acquire or earn new items and weapons. A simulation genre may involve the system enabling a user to acquire or earn game or metaverse money. A race genre may involve the system generating race circuits. A role playing game (RPG) genre may involve the system acquiring or earning experience points to level up characters. An adventure genre may involve the system unlocking or granting the user access to limited stories. A training genre may involve the system generating or granting a user character status, growth from input activity, etc. A card genre may involve the system generating original cards from input activity. A music genre may involve the system unlocking access to limited game events. A sports genre may involve the system unlocking access to limited teams, athletes, etc.

FIG. 6 is a chart 600 showing example service parameters and types of parameter-to-parameter (P2P) conversions, according to some implementations. Shown are parameters associated with unlock, acquire, and generate functions. In some implementations, an unlock function enables a user to get access to limited features, characters, stories, events, etc. An acquire function may enable a user to earn items, money, experience points, etc. A generate function may entail the system generating a new item (e.g., content, structure, growth, etc.)

In various embodiments, the following include service genres and examples of associated values that may be redeemed. A food delivery genre may involve the system unlocking a new menu. An e-book genre may involve the system enabling a user to acquire or earn a new story. A music streaming genre may involve the system generating a new playlist. An e-photo genre may involve the system generating a new photo book. An e-commerce genre may involve the system enabling a user to acquire or earn points. A video streaming genre may involve the system unlocking and enabling access to limited stories. A taxi genre may involve the system generating or granting a user a status (e.g., better car ride). A market place genre may involve the system generating a fee free coupon. An automotive genre may involve the system unlocking software base features. An amusement park/fan club genre may involve the system unlocking and enabling access to limited goods and tickets to purchase.

Referring still to FIG. 2, at block 210, the system displays a summary of the user behavior to the user. The summary may include information associated with the target behaviors, the behavior scores, and the behavior credits. Example implementations directed to summaries provided to a user are described in more detail herein.

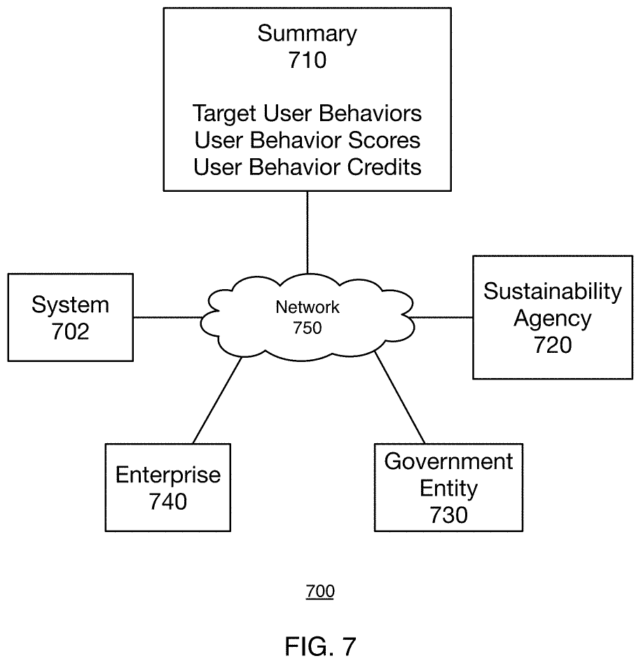

FIG. 7 is an example network environment 700 including a summary 710, according to some implementations. In various implementations, a system 702 provides a user with a summary 710, which summarizes the target behaviors, the behavior scores, and the behavior credits. The user may access summary 710 to monitor their target behaviors, the behavior scores, and the behavior credits to be incentivized to repeat such behaviors in the future. The user is rewarded for their actions by being able to redeem their earned behavior credits.

Also shown is sustainability agency 720, government entity 730, and enterprise 740, which may communicate with each other via a network 750. Network 750 may be any suitable communication network such as a Bluetooth network, a Wi-Fi network, the Internet, 5G, 6G, satellite constellations, etc.

In various implementations, the system may convert at least a portion of the behavior credits to sustainability credits. In various implementations, the system may transmit the sustainability credits on behalf of the user to one more entities such as sustainability agency 720, government entity 730, and enterprise 740 for a variety of benefits or rewards. For example, the system may send the sustainability credits to an employer who may match the value of the sustainability credits. The system or employer may in turn transfer the sustainability credits to a governing agency who may provide benefits or rewards to the user and/or employer. Such benefits or rewards may include, for example, tax incentives, ecological certifications, etc.

At block 212 of FIG. 2, the system enables the user to redeem the behavior credits. In various implementations, the system enables the behavior credits to be redeemed in one or more of the environments associated with the user, such as a mobility environment, metaverse environments, including gaming, etc.

Referring also still to FIG. 7, system 102 may communicate with sustainability agency 720 to enable a user to contribute donations using behavior credits, where the behavior credit may be converted to cash, crypto currencies, etc. for donation. System 102 may also communicate with government entity 730 or enterprise 740 to submit CO2 reduction data on behalf of the user in exchange for reward points for the user. System 702 collects CO2 reduction data and/or donations from the user and returns reward points or other items that the user redeems using behavior credits.

As indicated above, the system may convert scores or credits generated in one environment to another type of environment, or target environment. As such, the user may redeem the credits in the target environment.

In various implementations, the system enables the user to redeem behavior credits derived from behavior scores derived from a mobility environment to a metaverse environment, including gaming. For example, suppose that the system generates metaverse behavior credits or gaming behavior credits converted from mobility behavior credit or directly from mobility behavior scores in the mobility environment. In various implementations, the system may transfer the metaverse behavior credits to any other particular types of environments. The target environment may be user-selected. Once the metaverse behavior credits are in the metaverse environments, the system may enable the user to redeem the metaverse behavior credit. For example, the system may convert metaverse or game behavior credit into metaverse or game tokens for a particular target metaverse for exploring the metaverse or for a video game, where the metaverse tokens or gaming tokens may be applied to particular metaverse or video game benefits or assets (e.g., metaverse money or special powers, video game money or special powers, etc.). Further implementations directed to redemption of behavior credits are described in more detail herein.

In various implementations, the system enables the user to redeem behavior credits derived from behavior scores derived from a metaverse environments to a mobility environment. For example, the system may generate metaverse or gaming behavior credits. In an example of a driving game or metaverse exploration, where the user is training for ecological driving and accumulates gaming or metaverse behavior credits, the system may enable the user to redeem the gaming or metaverse behavior credits in a mobility environment. For example, the system may convert the gaming or metaverse behavior credits to mobility behavior credits and transfer those credits to a mobility environment. In the mobility environment, the user then may redeem the mobility behavior credits. For example, the system may enable the user to apply mobility behavior credits to discounts associated with driving (e.g., fuel discounts, toll discounts, etc.).

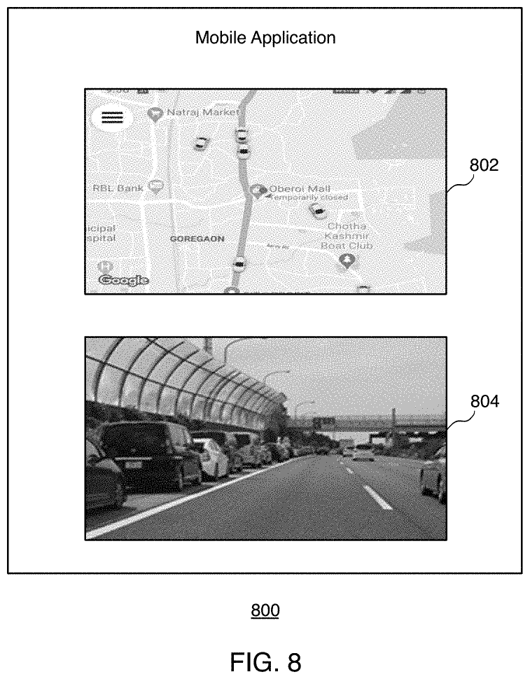

FIG. 8 is an example diagram of a mobile application 800, according to some implementations. As shown, mobile application 800 displays a map 802 and a photo 804. In various implementations, the display may show video footage in lieu of photo 804.

In various implementations, the system may function via mobile application 800 to enable a user to communicate and/or share traffic condition information with other users driving other cars. In some implementations, a user may tap on the mobile application if they wish to view traffic conditions, including seeing if there is a traffic jam up head. A user may request to see an image or video of traffic conditions, and a user may broadcast an image or video to be available to other users driving other cars. In some implementations, a user may tip other users for sharing useful information in association with traffic conditions. A tip may be in the form of cash or behavior credits.

In some implementations, the mobile application may enable a user to capture an image or video of speeding cars. The mobile application my send the image or video to the police to enable highway patrol to catch such drivers. The user may receive behavior credit for making such reports to the police.

Although the steps, operations, or computations may be presented in a specific order, the order may be changed in particular implementations. Other orderings of the steps are possible, depending on the particular embodiment. In some particular implementations, multiple steps shown as sequential in this specification may be performed at the same time. Also, some implementations may not have all of the steps shown and/or may have other steps instead of, or in addition to, those shown herein.

The following describes various implementations involving a driving simulation in a metaverse environments. In this example driving simulation, a scenario or problem is presented where a driver becomes sleepy or stressed when tired. Suppose that a parking area where the driver could sleep becomes crowded, there is a traffic jam in the parking area, or the driver otherwise has nowhere to sleep. Also suppose that the driver continues driving, which would result in dangerous driving, and which may cause an accident.

In this example, the user competes based on driving technique (as opposed to speed). As such, if the user keeps a distance from the car in front of the driver for 1 minute, the user gets a particular behavior score (e.g., 1). If the user drives behind the car by three car lengths, the behavior score doubles (e.g., 2). If the time every 100 meters is set according to the plan, the score is obtained. If the user passes a particular checkpoint on time, the user gets another score (e.g., 1) to be added to the first score. The system accumulates these behavior scores for the user.

The user may use or redeem the behavior score in two ways based on the video game. For example, the user may obtain a trophy or there may be an emergence of new courses for the user to drive.

The effect of this game results in some contribution to society. For example, it helps to train the driver/user in dealing with driver sleepiness and stress relief. It also trains the driver to contribute to CO2 reduction (e.g., driving with constant speed). It also helps the user to resolve traffic congestion issues (e.g., driving speed control).

The following describes various implementations involving another driving simulation in metaverse environments, including gaming environments. In this example driving simulation, a scenario or problem is presented similar to the previous scenario where a driver becomes sleepy or stressed when tired. Suppose that a parking area where the driver could sleep becomes crowded, there is a traffic jam in the parking area, or the driver otherwise has nowhere to sleep. Also suppose that the driver continues driving, which would result in dangerous driving, and which may cause an accident.

This example may involve an automobile society where “giving away a parking spot” and “parking quickly” are values. If a row of a parking lot is filled, the user/player gets a score (e.g., 1). If the user gives the parking spot to another car, the user may get a score by minimizing parking time.

The user may use or redeem the behavior score in two ways based on the video game. For example, the user may receive a coffee shop drink or service. The user may receive a parking space available for VIP.

The effect of this game results in some contribution to society. For example, it helps to train the driver/user in dealing with driver sleepiness and stress relief. It also helps the driver in contributing to the reduction of CO2 emissions. It also helps the driver in dealing with driver sleepiness. It also helps the driver to avoid scenarios with few parking spots on highways (e.g., dangerous parking)

The following describes various implementations involving an art simulation in metaverse environments. In this example art simulation, suppose that the user is pressed for the shortest distance and time, that the driver cannot drive with a sense of ease. Also suppose that there is no mechanism for refueling and collection while delivering efficiently.

In this example, driving art is made by several drivers, where the route makes a picture when the route is traced on a map. The routes are set up with points a laid out on the map at a delivery location, a refueling location, charging points, and landmarks. The drivers who participate in the game contribute to the completion of the picture by driving a part from A point to B point. Multiple drivers drive to complete the painting. The finished product can be sold as a nonfungible token (NFT) or converted into a cryptocurrency. The finished product may also be used as an advertisement for company logos. The user may set the difficulty level by leaving the last portion of the route in a mountainous area or in a place where typically people do not pass.

The effect of this game may have several results. For example, for delivery providers, the game sets the delivery route that increases delivery efficiency. For drivers, the game makes deliveries fun and stress-reducing.

Implementations described herein provide various benefits. For example, implementations enable the user to own and be in control of the user's behavioral data. Implementations described herein also provide the user with a summary that enables the user to visualize what data has been collected and the value of the user's historical behavioral data, as well as associated scores and redeemable credits based on the behavioral data. Implementations described herein also enable the user to redeem behavioral credits across different environments.

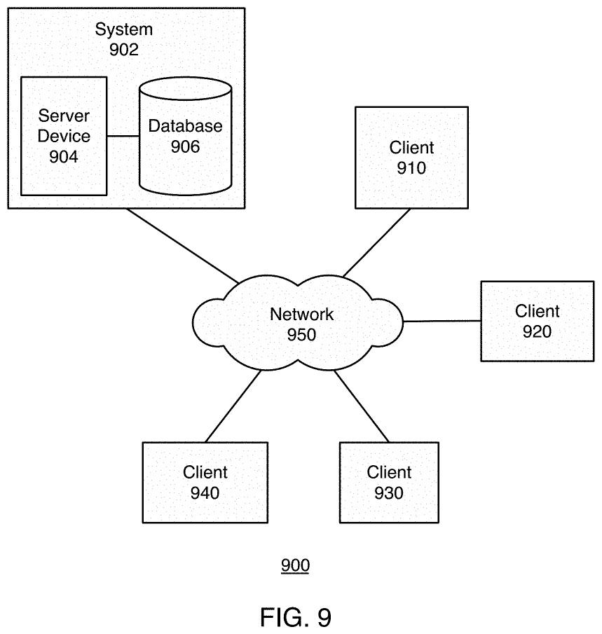

FIG. 9 is a block diagram of an example network environment 900, which may be used for some implementations described herein. In some implementations, network environment 900 includes a system 902, which includes a server device 904 and a database 906. For example, system 902 may be used to implement system 102 of FIG. 1, as well as to perform implementations described herein. Network environment 900 also includes client devices 910, 920, 930, and 940, which may communicate with system 902 and/or may communicate with each other directly or via system 902. Network environment 900 also includes a network 950 through which system 902 and client devices 910, 920, 930, and 940 communicate. Network 950 may be any suitable communication network such as a Wi-Fi network, Bluetooth network, the Internet, 5G, 6G, satellite constellations, etc.

For ease of illustration, FIG. 9 shows one block for each of system 902, server device 904, and network database 906, and shows four blocks for client devices 910, 920, 930, and 940. Blocks 902, 904, and 906 may represent multiple systems, server devices, and network databases. Also, there may be any number of client devices. In other implementations, environment 900 may not have all of the components shown and/or may have other elements including other types of elements instead of, or in addition to, those shown herein.

While server device 904 of system 902 performs implementations described herein, in other implementations, any suitable component or combination of components associated with system 902 or any suitable processor or processors associated with system 902 may facilitate performing the implementations described herein.

In the various implementations described herein, a processor of system 902 and/or a processor of any client device 910, 920, 930, and 940 cause the elements described herein (e.g., information, etc.) to be displayed in a user interface on one or more display screens.

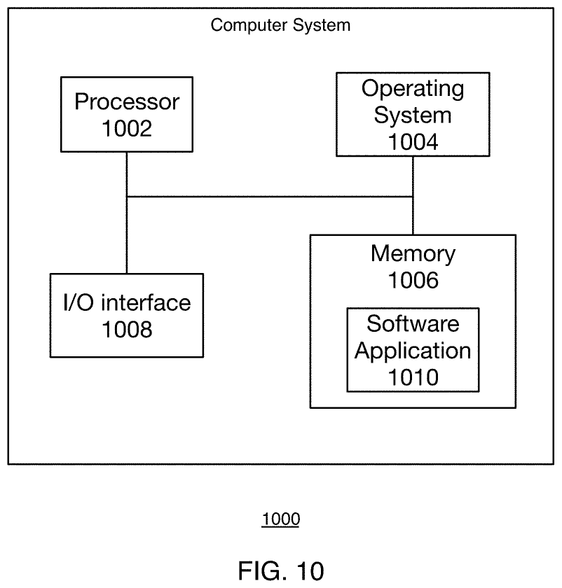

FIG. 10 is a block diagram of an example computer system 1000, which may be used for some implementations described herein. For example, computer system 1000 may be used to implement server device 904 of FIG. 9 and/or system 102 of FIG. 1, as well as to perform implementations described herein. In some implementations, computer system 1000 may include a processor 1002, an operating system 1004, a memory 1006, and an input/output (I/O) interface 1008. In various implementations, processor 1002 may be used to implement various functions and features described herein, as well as to perform the method implementations described herein. While processor 1002 is described as performing implementations described herein, any suitable component or combination of components of computer system 1000 or any suitable processor or processors associated with computer system 1000 or any suitable system may perform the steps described. Implementations described herein may be carried out on a user device, on a server, or a combination of both.

Computer system 1000 also includes a software application 1010, which may be stored on memory 1006 or on any other suitable storage location or computer-readable medium. Software application 1010 provides instructions that enable processor 1002 to perform the implementations described herein and other functions. Software application may also include an engine such as a network engine for performing various functions associated with one or more networks and network communications. The components of computer system 1000 may be implemented by one or more processors or any combination of hardware devices, as well as any combination of hardware, software, firmware, etc.

For ease of illustration, FIG. 10 shows one block for each of processor 1002, operating system 1004, memory 1006, I/O interface 1008, and software application 1010. These blocks 1002, 1004, 1006, 1008, and 1010 may represent multiple processors, operating systems, memories, I/O interfaces, and software applications. In various implementations, computer system 1000 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C #, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular implementations may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular implementations can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to cause the one or more processors to perform operations comprising:
tracking, using capture devices, user behavior of a user, wherein the capture devices capture the user behavior performed by the user in environments associated with the user;
identifying target behaviors from the user behavior;
computing behavior scores for each target behavior of the target behaviors based on predetermined scoring criteria;
converting the behavior scores into behavior credits based on predetermined credit criteria;
displaying a summary of the user behavior to the user, wherein the summary comprises information associated with the target behaviors, the behavior scores, and the behavior credits; and
enabling the user to redeem the behavior credits, wherein the behavior credits are derived from behavior scores associated with a metaverse environment, wherein the behavior credits are associated with the metaverse environment, wherein the behavior credits are transferred from the metaverse environment to a mobility environment, and wherein the user redeems the behavior credits associated with the metaverse environment in the mobility environment.

2. The system of claim 1, wherein at least some of the predetermined scoring criteria are based on user activity in the mobility environment.

3. The system of claim 1, wherein at least some of the predetermined scoring criteria are based on user activity in the metaverse environment.

4. The system of claim 1, wherein the logic when executed is further operable to cause the one or more processors to perform operations comprising enabling the behavior credits to be redeemed in one or more of the environments associated with the user.

5. The system of claim 1, wherein the logic when executed is further operable to cause the one or more processors to perform operations comprising enabling the user to redeem behavior credits derived from behavior scores derived from the mobility environment to the metaverse environment.

6. The system of claim 1, wherein the logic when executed is further operable to cause the one or more processors to perform operations comprising enabling the user to redeem behavior credits derived from behavior scores derived from the metaverse environment to the mobility environment.

7. The system of claim 1, wherein the logic when executed is further operable to cause the one or more processors to perform operations comprising converting at least a portion of the behavior credits to sustainability credits.

8. A non-transitory computer-readable storage medium with program instructions stored thereon, the program instructions when executed by one or more processors are operable to cause the one or more processors to perform operations comprising:
tracking, using capture devices, user behavior of a user, wherein the capture devices capture the user behavior performed by the user in environments associated with the user;
identifying target behaviors from the user behavior;
computing behavior scores for each target behavior of the target behaviors based on predetermined scoring criteria;
converting the behavior scores into behavior credits based on predetermined credit criteria;
displaying a summary of the user behavior to the user, wherein the summary comprises information associated with the target behaviors, the behavior scores, and the behavior credits; and
enabling the user to redeem the behavior credits, wherein the behavior credits are derived from behavior scores associated with a metaverse environment, wherein the behavior credits are associated with the metaverse environment, wherein the behavior credits are transferred from the metaverse environment to a mobility environment, and wherein the user redeems the behavior credits associated with the metaverse environment in the mobility environment.

9. The computer-readable storage medium of claim 8, wherein at least some of the predetermined scoring criteria are based on user activity in the mobility environment.

10. The computer-readable storage medium of claim 8, wherein at least some of the predetermined scoring criteria are based on user activity in the metaverse environment.

11. The computer-readable storage medium of claim 8, wherein the instructions when executed are further operable to cause the one or more processors to perform operations comprising enabling the behavior credits to be redeemed in one or more of the environments associated with the user.

12. The computer-readable storage medium of claim 8, wherein the instructions when executed are further operable to cause the one or more processors to perform operations comprising enabling the user to redeem behavior credits derived from behavior scores derived from the mobility environment to the metaverse environment.

13. The computer-readable storage medium of claim 8, wherein the instructions when executed are further operable to cause the one or more processors to perform operations comprising enabling the user to redeem behavior credits derived from behavior scores derived from the metaverse environment to the mobility environment.

14. The computer-readable storage medium of claim 8, wherein the instructions when executed are further operable to cause the one or more processors to perform operations comprising converting at least a portion of the behavior credits to sustainability credits.

15. A computer-implemented method comprising:
tracking, using capture devices, user behavior of a user, wherein the capture devices capture the user behavior performed by the user in environments associated with the user;
identifying target behaviors from the user behavior;
computing behavior scores for each target behavior of the target behaviors based on predetermined scoring criteria;
converting the behavior scores into behavior credits based on predetermined credit criteria;
displaying a summary of the user behavior to the user, wherein the summary comprises information associated with the target behaviors, the behavior scores, and the behavior credits; and
enabling the user to redeem the behavior credits, wherein the behavior credits are derived from behavior scores associated with a metaverse environment, wherein the behavior credits are associated with the metaverse environment, wherein the behavior credits are transferred from the metaverse environment to a mobility environment, and wherein the user redeems the behavior credits associated with the metaverse environment in the mobility environment.

16. The method of claim 15, wherein at least some of the predetermined scoring criteria are based on user activity in the mobility environment.

17. The method of claim 15, wherein at least some of the predetermined scoring criteria are based on user activity in the metaverse environment.

18. The method of claim 15, further comprising enabling the behavior credits to be redeemed in one or more of the environments associated with the user.

19. The method of claim 15, further comprising enabling the user to redeem behavior credits derived from behavior scores derived from the mobility environment to the metaverse environment.

20. The method of claim 15, further comprising enabling the user to redeem behavior credits derived from behavior scores derived from the metaverse environment to the mobility environment.
